(19) United States
(12) Patent Application Publication
(10) Pub. No.: US 2005/0040108 A1
(43) Pub. Date: Feb. 24, 2005

(54) Metal ion recovery

(76) Inventor: William H. Jay, Daylesford (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/490,762

(22) PCT Filed: Sep. 24, 2002
(86) PCT No.: PCT/AU02/01298

(30) Foreign Application Priority Data
Sep. 26, 2001 (AU) PR 7916

(51) Int. Cl. B01D 11/00

(52) U.S. Cl. 210/638; 210/651; 210/684; 210/805

(57) ABSTRACT

A process for the recovery or removal of metal species from a solution or slurry is described, which comprises the steps of contacting the solution or slurry with a poly(alkyleneimine) polymeric material to load the poly(alkyleneimine) polymeric material with metal species; separating the loaded poly(alkyleneimine) polymeric material from the solution or slurry; and recovering or removing the metal from the poly(alkyleneimine) polymeric material.

The present invention relates to the recovery of metal values from solutions or from slurries. In particular, the present invention relates to polymeric materials and the use thereof for the recovery of metal values from solutions or slurries, to processes for the recovery of metal species from solution using polymeric materials and to methods for the recovery of metal values from these polymeric materials. More particularly, the invention relates to the use of poly(alkyleneimine) (or PAI) polymeric material in the recovery of metal values from solutions or slurries.

Methods for the removal or recovery of metal ions from aqueous solutions may be divided into a number of general categories, namely:
(a) extraction using solid extractants such as functionalised ion exchange resins, activated carbon, and inorganic materials onto the surfaces of which covalently bound functional polymers are fixed;
(b) extraction using liquid solvent extractants solubilised in a solvent which is immiscible with the feed solvent. In this case, large volumes of highly imflammable hydrocarbon solvents are required which can result in the loss of valuable extractant due to either entrainment or its slight solubility in the feed stream;
(c) membrane processes in which one or more of the ions migrating through the pores in a membrane are collected in an affinity solvent on the permeate side of the membrane, or are alternatively concentrated in the retentate;
(d) precipitation, preferably as metal hydroxides, or as carbonates, sulphates, etc. can non-selectively remove metal ions from aqueous streams. However, the metal hydroxide sludges may be difficult to dewater. If a number of metal ions are present, then they will not reach minimum solubility at the same pH, rendering it difficult to meet effluent standards; and
(e) electrolysis methods to recover valuable metal ions from solution in metallic form.

One of the above techniques may be used singly, or more than one of the above techniques may be used in combination in various embodiments of the present invention.

According to one aspect of the present invention there is provided a process for the recovery or removal of metal species from a solution or slurry comprising the steps of:
(a) contacting the solution or slurry with a poly(alkyleneimine) polymeric material to load the polymeric material with metal species;
(b) separating the loaded polymeric material from the solution or slurry; and
(c) recovering or removing the metal from the polymeric material.

According to one particular aspect of the invention there is provided a process for the recovery or removal of metal species from a leach solution or slurry which contains metal ions or metal complexes wherein the leach solution or slurry is contacted with the polymeric material for a period sufficient for the metal species to be bound to the polymeric material, and with anionic species such that at least a portion of the ligands of the metal complexes are displaced therefrom and returned to the leach solution or slurry whereby, if the displaced ligands act as a lixiviant, they are then available to react with further metal values.

These aspects and further aspects of the invention will be described in further detail within the following disclosure of the invention.

As used herein the terms “poly(alkyleneimine) containing polymeric material” and “poly(alkyleneimine) polymeric material” include polymeric materials which include a ploy(alkyleneimine) polymer (or PAI polymer), produced by the reaction of ethyleneimine monomer with a polymer backbone, preferably a nitrogen-containing polymer, to form pendant polyethyleneimine chains. The term also includes materials which include modified versions of such polymers following reaction, for example, of primary nitrogen groups with alkoxy or alkyl functional molecules to provide additional crosslinking. Thus, the poly(alkyleneimine) polymeric material includes grafted and/or grafted and crosslinked molecules and, as such, may be prepared in a manner such that nitrogen functional groups of the material can be more favorably positioned compared with prior art materials.

As used herein the term “superhydrophilic urethane-urea” will be understood to refer to expanded polymers which may be alternatively described as “highly hydrophilic”, “superhydrophilic” or superabsorbent”. These polymers in their unmodified and expanded state accept and rapidly absorb significant quantities of water. Materials of this type will absorb a drop of water placed on a surface of the material in a reasonably short period of time and will also vertically wick and absorb water from a pool.

As used herein the term “water insoluble polymer” will be understood to refer to long chain nitrogen-, oxygen-, and/or sulphur containing polymers and also long chain polymers containing a combination of nitrogen molecules with oxygen and/or sulphur molecules. Such polymers have been rendered water insoluble and where applicable, soluble in water insoluble carrier solutions such as kerosene-based hydrocarbon cuts. Poly(alkyleneimine) derivatives with molecular weights generally in excess of 500 which are crosslinked, grafted and/or chain extended and where required, modified as described herein, represent suitable examples of water insoluble polymers included in the present invention. Water insoluble polymers of this type can generally be readily incorporated into superhydrophilic urethane-urea resinous materials.

As used herein the term “water soluble polymer” will be understood to refer to long chain nitrogen-, oxygen-, and/or sulphur containing polymers and also long chain polymers containing a combination of nitrogen molecules with oxygen and/or sulphur molecules. Poly(alkyleneimine) derivatives with molecular weights generally in excess of 500 which are crosslinked, grafted and/or chain extended and where required, modified as described herein, represent suitable examples of water soluble polymers included in the present invention.

Metal ion complexation reagents may be broadly divided into the following general types, namely: water soluble chelating or co-ordinating agents; chemically modified water soluble chelating or co-ordinating agents; and water insoluble chelating or co-ordinating agents. These will be dealt with in turn below.

Water soluble chelating or co-ordinating agents include polymers capable of capturing metal species in a host-guest relationship such as by forming ionic bonds with the metal and displacing at least a portion of the ligands of the metal complex.

For example, polyethylene oxide based polymers grafted and/or crosslinked and containing a portion of polyethyleneimine may be provided, the polyethyleneimine being either tipped or incorporated into the polymer structure. These polymers will be described in more detail herein. When required, the polymer structure may be modified by reactions such as amination, oximation, hydroxamation, dithiocarbamation, phosphorylation, sulphonation, etc. to provide the polymer with more selective metal ion extraction properties. It has been established that in the manufacture of polyethyleneimines and modified PAI derivatives that “tail biting” or macrocycle formation may occur. This has the potential to more favourably place or position the functional nitrogens, oxygens, sulphur groups, hydroxyl groups etc for the metal ion complexation reactions. Furthermore, the flexibility or the different crystalinity of the other polymers incorporated into these modified PAI structures can aid in the complexation of metal ions. For example, poly(ethylene oxide) gauche states for the bonds will readily bring O atoms into close proximity and thus be able to complex with a number of metallic anionic species. This well known coil structure in which these ether oxygens are favourably placed to complex with anionic species has been researched and reported. Whereas the poly(oxypropylene) chain is planar in structure and does not complex with anionic metallic species to the same extent.

Thus, poly(alkyleneimine) polymers (hereinafter referred to as “PAI polymers” or “modified PAI polymers”) included within the scope of this invention are, for example, capable of capturing metal ions and displacing a cyanide ion associated with the metal.

Incorporation of these PAI polymers into a superhydrophilic urethane-urea or a polystyrene divinyl benzene or acrylic resin will enable metal ions to be displaced from cyanide ions thereby enabling the anionic ligands to continue to act as a lixiviant. Alternatively, by modification of the charge density, metal cyanide complexes may be selectively recovered from solutions or slurries. Thus, separation of copper cyanide complexes from gold cyanide may be achieved. Methods for incorporation of these modified PAI polymers into a solid polymer will be discussed herein.

Preferably, the PAI polymer contains primary, secondary and tertiary and may include quaternary amine functionality. Preferably, this modified PAI should maintain its water solubility over the pH range of 1-14. In addition to polyethyleneimine backbones, other nitrogen-containing polymers such as poly(allylamine) or poly(vinylamine), polyacrylamides, or polymer backbones such as poly(acrylonitrile), poly(vinyl alcohol) may be considered as starting polymers onto which polyethyleneimine is grafted. Alternatively, oxygen and/or sulphur group-containing polymer may be incorporated into the polymer structure by direct reaction or by crosslinking reactions. The polyethyleneimine may form the major portion of the polymer structure, or may provide less than 50% of the final polymer formulation.

Thus, the branched chain polyethyleneimines, the subject of WO01/34856, U.S. Pat. No. 5,643,456, and U.S. Pat. No. 5,766,478 are long chain polymers in which the ratio of primary to secondary to tertiary amines is approximately 1:2:1. Whereas, the PAI-based polymers the subject of this invention are grafted polymers and/or grafted and crosslinked polymers and therefore are significantly different in molecular structure to the branched polyethyleneimines the subject of earlier patents.

In a preferred molecular structure, polyethyleneimine chains are grafted onto a nitrogen-containing polymer such as a linear polyethyleneimine, a branched polyethyleneimine, poly(vinylamine), poly(allylamine) or a polyacrylamide by causing ethyleneimine monomer to react onto a percentage of the primary amine groups present in the base polymer structure preferably by an acid catalysed reaction to form pendant polyethyleneimine chains. In a preferred grafted polymer, the molecular weight of the polymer used as the backbone for the grafting step and containing a percentage of primary amine groups can vary from less than 100 to more than 1,000,000 but is generally in the range of 50,000 to 500,000. By control of the ethyleneimine polymerisation reaction, the chain length of the pendant polyethyleneimine portion may be quite short. Its specific molecular weight may be calculated to be in the order of 500 to 50,000, but can be significantly greater than these postulated molecular weights.

Poly(acrylonitrile), poly(vinyl alcohol) or other similar polymer are able to react with primary amines present in low molecular weight polyethyleneimine polymers to form pendant polyethyleneimine chains. As such, these polymers are included in the PAI derivatives the subject of this discovery.

Another alternative PAI-based polymer the subject of this invention may be obtained by reacting primary amines present on two branched polyethyleneimine chains with alkoxy or alkyl functional molecules of variable chain length.

These grafted poly(alkyleneimine) polymers (herein referred to as PAI-based polymers) may be crosslinked by a number of different reactions such as base-catalysed condensation reactions using dicarboxylic acids, diesters, acid chloride derivatives of dicarboxylic acids, diacyl chlorides, dialkyl chlorides, poly(ethylene oxide), poly(propylene oxide), poly(butylene oxide) or diisocyanates or other reactant to significantly increase the molecular weight of the grafted PAI polymer and significantly reduce the charge density of the final polymer. That is, this crosslinking reaction increases the molecular weight of the PAI-based polymer, adds flexibility to the molecular structure and provides reactive sites more favourably disposed for metal ion complexation or co-ordination reactions.

Further reactions may be conducted, preferably at the primary amine sites present in the PAI polymer by reactions well known to those skilled in the art. A number of non-limiting reactions are given in the examples which form part of this invention. These modification reactions include amination, oximation, hydroxamation, dithiocarbamation, phosphorylation, sulphonation, etc. and thereby provide the polymer with more selective metal ion extraction properties. The more favourable structure of the grafted or grafted and crosslinked PAI-based polymers enhances the metal ion complexation or co-ordination reactions.

Applications.

Water soluble polyethyleneimine-based polymers have been proposed for the displacement of copper and other metals from their copper cyanide complex in U.S. Pat. No. 5,643,456 and in WO01/34856 and which are specifically incorporated by reference.

According to a particular embodiment of the present invention there is provided a process for the recovery of metal species from a solution or slurry containing metal cyanide species, comprising the steps of:
(a) contacting the solution or slurry with a water soluble poly(alkyleneimine) containing polymeric chelating or co-ordinating agent, preferably containing sodium benzoate, to load the water soluble polymeric agent with the metal species;
(b) separating the loaded water soluble polymeric agent by membrane separation such that cyanide is displaced and reports in the permeate and complexed metal species reports in the retentate;
(c) recovering the metal species from the retentate; and optionally
(d) recirculating the cyanide-rich permeate from step (b) and/or water soluble polymeric agent-rich solution following step (c).

It is preferable that if any free cyanide exists in the cyanide-containing aqueous stream, for example copper cyanide aqueous stream, that it is removed by membrane separation prior to the introduction of the water soluble polymeric agent, for example as referred to hereafter as the modified PAI-based polymer. This removal step will have the added advantage of reducing the volume of solution to be treated for copper cyanide removal. The permeate will then contain the free cyanide ions (and be immediately available for recycle) and the retentate will contain the copper cyanide ions in a reduced volume of water. A suitable membrane would be of the types described in, for example, U.S. Pat. No. 4,741,831, U.S. Pat. No. 4,770,784, U.S. Pat. No. 4,895,659, U.S. Pat. No. 5,266,203 and U.S. Pat. No. 5,643,456. Polysulphone-based membranes have been found to be particularly efficacious. The modified PAI-based polymer may then be introduced into the copper cyanide retentate solution and thus become the feed for the second membrane cartridge. Therefore, this second membrane cartridge may be considered as a “displacement reactor” in which the PAI polymer complexes with the copper ions and displacing cyanide ions. Ultrafiltration may then be used to separate the copper-PAI polymer from the cyanide ions. Not all of the cyanide ions may be displaced from the copper-PAI polymer complex. However, as will be shown, these cyanide ions will then be released preferably by direct electrowinning in a membrane type electrolysis cell employed to recover the copper. Alternatively, acidification as described in U.S. Pat. No. 5,643,456, may be used to recover the copper. However, careful attention must be given to the potential for HCN generation.

As reported in WO01/34856, if the metal ion can be reduced to its metallic state in an electrowinning cell, then in a similar manner the metal is able to be preferably recovered directly from the PAI-based polymer complex by such electrolysis processes. With this in mind, the destruction of cyanide ions which would occur, or oxidation of the PAI polymer if these ions or polymer contact the anodic electrode should be considered. Thus, because the polymeric displacement solution leaving the membrane cell may still contain residual cyanide ions or metal cyanide complexes and all of the PAI-based polymer, it is desirable that an electrochemical cell incorporating a membrane be employed to maximise cyanide recoveries and minimise cyanide and polymer destruction. Furthermore, U.S. Pat. No. 4,857,159 identifies that metal cyanides which are among the most dangerous of chemical pollutants, are most often dealt with by destruction methods such as chlorination, electrolysis and catalytic methods. They offer methods for recovering metals less dangerous than cyanides, but do not further address this toxic chemical. The methodology, the subject of embodiments of this invention serves to treat such cyanide-containing aqueous streams such that the cyanide can be economically recovered rather than destroyed.

An additional property exhibited by water soluble polyethyleneimine-based polymers, and considered by the invention, is their ability to coat the surface of a gold particle, thereby reducing the dissolution kinetics. As little as 5 ppm of a polyethyleneimine-based polymer can inhibit gold dissolution in oxygenated alkaline cyanide solutions. Reduction in the charge density of the polyethyleneimine by its transformation into the PAI-based polymers the subject of this invention, modifies the ability of polyethyleneimines to inhibit gold dissolution.

Thus, in a preferred separation mechanism, free cyanide ions and a proportion of the water may be removed from the feed solution by membrane separation prior to the introduction of the PAI-based polymer. This cyanide-containing solution can be directly returned to the milling and/or leaching circuits. A more concentrated feed solution is then available for metal ion separation and recovery of all desirable ionic species.

Alternatively, the cyanide ions passing through the membrane walls can then either be destroyed or preferably recovered and recycled by known methods. Such methods include direct recycle, ion exchange concentration and/or membrane concentration such as described in U.S. Pat. Nos. 4,895,659 and 5,266,203 and which are specifically incorporated by reference. As reported herein, the removal of all modified PAI from this recycle stream is preferably accomplished before any solutions containing cyanide ions are recycled. Affinity dialysis for the economic separation of copper and cyanide ions from copper cyanide complexes forms part of the proposed applications for this discovery.

It is contemplated in this invention that two or more polymers or reagents capable of forming metal complexes may be used in combination. Thus, a low molecular weight polyamine derivative may be combined with a high molecular weight PAI-based polymer. Alternatively, a polyethyleneimine polymer, with or without a polyamine may be combined with a PAI-based polymer. Each metal ion scavenger may be capable of complexing with different metal ions present in the feed solution. Then, by selection of a membrane with suitable pore size, desired complexes could pass through the membrane (permeate) and other metal complex retained (retentate) so that a separation of two or more metals could be achieved.

Alternatively, if the pore size of the selected membrane was such that all polymers were retained, then the opportunity to remove additional metal ions from a stream is enhanced.

Chemically modified water soluble chelating or co-ordinating agents which include polyethyleneimine and PAI-based polymers onto which ditihiocarbamate groups have been formed offer a unique method for the recovery of copper from cyanide solution and allow the cyanide to be recycled. This type of polymer is capable of complexing with the copper and forming a precipitate. Thus, the precipitated copper is recovered from solution in a high rate thickener, filter press or other suitable solid/liquid separation device and the cyanide-containing solution is recycled. The process is conducted under alkaline conditions, thereby effectively eliminating the formation or evolution of HCN. Thus, those skilled in the art would recognise that the procedure is similar in many respects to the SART process and could be conducted in an existing SART plant. It would have the advantage over the SART process in that no sulphuric acid or additional lime is required and HCN gas is not an issue.

Water insoluble chelating or co-ordinating agents are also the subject of a co-pending patent application. Thus, these polymers will form part of the claims for this co-pending application. Water insolubility may be created by reacting a number of the amine sites present in the PAI-based polymers the subject of this invention, with long chain aliphatic reagents such as stearic acid. Reaction of no more than 20% of the amine sites with stearic acid will produce water insolubility. Whilst these polymers are insoluble in water they are soluble in water insoluble alcohols. Thus, when dissolved in a water-insoluble alcohol such as tridecanol, the resultant product is then capable of being dissolved in kerosene fractions such as Exon Chemicals Escaid 100 or Shell Chemical's Shellsol 2046. This discovery enables the favourable properties exhibited by PAI-based polymers to be used in solvent extraction applications. The ability to modify both the charge density of polyethyleneimine polymers and to modify their surface tension properties provides PAI-based polymers advantages over polyethyleneimine polymers described in WO01/34856. Additionally, further modification of these polymers by oximation, hydroxamation, etc. can provide added selectivity for specific metal ions.

The modified PAI polymers may be further altered chemically such as for example by the addition of a pendant pyridine or other group in conjunction with alkyl amine groups as described in U.S. Pat. No. 4,741,831 and which is incorporated herein by reference. An ethoxylated, PAI-based polymer may have the pendant hydroxyl groups reacted to fix the polymer to a solid support. Or, sufficient of the amine sites present in the PAI-based polymer may be reacted with say the carboxylic acid sites on for example, an iminodiacetate-based polystyrene-divinyl benzene resin to render the resultant product water insoluble. The modified PAI polymers may also be quaternised as described in U.S. Pat. No. 5,087,359 and incorporated herein by reference. Particularly important reactions, include the dithiocarbamation or the hydroxamation of the amine sites to more strongly recover copper from acidic solutions such as acid mine drainage, or from copper cyanide solutions.

The presence of an alcohol, particularly a water insoluble alcohol, may enhance the sorption properties of the solid and of the liquid extractant PAI-based polymers. It is understood that the term “alcohol” also includes phenols and organic molecules containing the —OH moiety. It will be understood that the term “substantially insoluble” means the alcohol is insoluble in the lixiviant solution although a small amount or insignificant amount of the alcohol may dissolve in the lixiviant solution. Suitable alcohols include n-pentanol, n-hexanol, 2-ethylhexanol, isodecanol, dodecanol, tridecanol, hexadecanol, octadecanol; phenols such as heptylphenol, octylphenol, nonylphenol, and dodecyphenol. Preferably the alcohol is a non-aromatic alcohol. The preferred non-aromatic alcohols include pentanol, isodecanol and isotridecanol. These alcohols may be imbibed into solid polymers exhibiting ion exchanging, ion capturing and ion displacement reactions to solvate the ligand sites already present within or on the surface of these materials.

Modifiers such as organophosphorus compounds including tributyl phosphate, dibutyl butyl phosphonate, di- and tri-(2-ethylhexyl) phosphate may also be incorporated into formulations. Dialkyl phosphorodithioic acids, phosphonates, sulphur-containing methyl phosphonates, ketophosphonates, and trialkyl thiophosphonates for example, are also able to be considered. It is suggested that these reagents probably act by solvating an electrically neutral ion association complex. These compounds may be imbibed into solid polymers exhibiting ion exchanging, ion capturing and ion displacement reactions to solvate the ligand sites already present within or on the surface of these materials.

Thus, according to a particular embodiments, the invention provides alternative processes for the recovery of metal species from a solution or slurry containing metal cyanide species, comprising steps of:
(a) contacting the solution or slurry with a poly(alkyleneimine) containing water insoluble polymeric chelating or co-ordinating agent to load the water insoluble polymeric agent with the metal species;
(b) separating the loaded water insoluble polymeric agent by either solid/liquid separation such that cyanide which is displaced reports in the aqueous phase and complexed metal species reports in the solid phase or the organic phase;
(c) recovering the metal species from the solid or from the organic phase; and optionally
(d) recirculating the cyanide-rich solution from step (b) and/or the solid or the water-insoluble polymeric agent-rich solution following step (c).
   Non-Limiting Application Procedures

As stated, the polymeric materials of the present invention are capable of capturing and thereby recovering desired metal values from aqueous solutions and slurries. The metal values may be in the form of cations, anions, or metal complexes. In capturing a metal ion, the associated counter ion may be released back into the leach solution and/or slurry and/or can in some instances remain loosely bound to the captured metal ion. When released, this may therefore continue to act as a lixiviant. Alternatively, if it remains associated with the metal ion, then it is able to be readily eluted from the polymer. Preferably, the polymeric materials are used in a cyclic process.

Whilst these processes are intended to be used in the recovery of precious and related metals it is not confined to those metals. For example, it is envisaged that certain of the PAI-based polymers the subject of the invention, could be readily used in acid mine drainage applications to concentrate say a copper ion for a subsequent electrowinning process.

Gold Hydrometallurgy.

The preferred lixiviant used in the gold industry is sodium cyanide. Work is being conducted into the application of thiosulphate-based lixiviants, but to date they have not proved to acceptable to the gold industry. Thus, the metals of interest for recovery are those which form strong complexes with cyanide and include gold, silver, copper, zinc, iron, nickel, cadmium, mercury and cobalt; or the gold, silver and copper thiosulphate complexes. Polyethyleneimine has been demonstrated to bind too strongly to the copper to enable it to be used in thiosulphate-based leach systems. However, the reduced and controllable charge density able to be achieved with the PAI-based polymers now provides an alternative complexant for this potential industrial process.

With cyanide lixiviants, it is desirable to recover the metal complex from the slurry using a solid/liquid system. However, where clear solutions are generated such as in heap, vat or dump leaching, either liquid/liquid extraction or solid/liquid extraction methods may be adopted.

The removal or recovery of metal species from slurries by the application of a solid sorbent such as the recovery of gold cyanide using coarse particles of activated carbon, is an important aspect of mining operations. Activated carbon adsorbs the gold cyanide anion and may be recovered directly from the slurry by simple screening. This obviates the need for the separation of the gold-containing solution from the leached gangue minerals as was required in earlier cementation gold recovery processes. The process is known as the carbon-in-pulp (CIP) process when carbon is introduced into the slurry after gold dissolution has been achieved, or the carbon-in-leach (CIL) process when the leaching of the gold and the recovery of the gold cyanide on activated carbon occurs in the same vessels. Ion exchange resins have been substituted for activated carbon and the process has been renamed as the resin-in-pulp process (RIP).

Whilst carbon has obvious disadvantages due to its poor resistance to attrition and its need for thermal regeneration, it is relatively selective towards gold cyanide if the leaching conditions are controlled so that other metal ions are maintained in a valency state less suited to their adsorption by this material. Ion exchange resins have been widely adopted due to their small bead size. WO99/15273 which is incorporated herein by reference offers one method for overcoming this particle size deficiency without loss in either kinetics of loading and stripping or in ultimate useful loading capacity.

Furthermore, in the leaching of copper-gold ores using sodium cyanide, copper usually dissolves more rapidly than gold in cyanide solutions. Thus, if the solid forms of the PAI-based polymers the subject of this invention are introduced into the leach vessels (polymer-in-pulp) to recover copper and potentially release cyanide, then the cyanide can continue to dissolve gold. The gold cyanide can then be recovered by conventional CIP technology. Thus, the solid polymeric materials, disclosed in this application, may be conveniently used as an aid to activated carbon in the well known RIP process, or in conventional CIP technology. The particle size may therefore be able to be adjusted to be of sufficient size to replicate the size of activated carbons so that they can also be easily recovered from slurries by conventional screening operations.

In another preferred embodiment of this PAI-based technology, very high molecular weight, water soluble versions may be produced in which the charge density is suitably selected. Then, by a normal dithiocarbamate reaction for example, the available sulphur groups can bind to copper under alkaline conditions and displace cyanide ions. The copper will form a precipitate and can be recovered in a high rate thickener, filter press, or other suitable solid/liquid separation equipment. The released cyanide may then be recycled. The copper-containing PAI-based polymer precipitate is recovered, copper is released, typically by acidification and recovered by electrowinning. The polymer is then recycled. If copper or zinc ions, preferably in intimate association with an ion exchange resin, are added to the slurry immediately prior to its discharge to the tailings impoundment, then free cyanide can be recovered from solution. For example, an ion exchange resin with either metallic copper or CuCN on its surface is added to the slurry or solution, then in the presence of free cyanide, these copper species will be converted to soluble, copper cyanide complexes which are capable of being retained on quaternary amine functional resins. The copper cyanide complexes are then eluted (or stripped) from the solid ion exchange resin using a high pH (preferably NaOH) solution under controlled redox potential and which preferably contains sodium benzoate, a thiocyanate and/or an acrylic based polymer as the eluent. The eluent solution may be at a temperature of 20-60° C. and may be deficient in oxygen. The copper cyanide solution can then be further concentrated by contact with the PAI-based polymer enabling the alkaline cyanide solution to pass through a membrane and either returned to the leach circuit or to the stripping circuit. Preferably, the copper is directly recovered from the modified PAI-containing eluent by electrowinning in a suitable membrane cell. Alternatively, the polymer is then acidified to displace the captured copper ions and the copper is recovered in an electrolysis cell. In a further embodiment, the acidified solution may be sulphidised using Na₂S or NaSH and if required, a flocculent added to recover the copper as copper sulphide.

The disclosures in respect of the treatment of cyanide solutions, particularly the treatment of the more stable and cyanide consuming copper cyanide solutions and methods by which both the metal and the cyanide ions can be economically recovered are of significant industrial importance. Furthermore, it provides methods by which cyanide can be retained within the leach plant, thereby not being released into the environment.

(b) Acid Mine Drainage.

Acid drainage or acid mine drainage results from sulphide-containing rock, ore, mullock, soil, or other sulphide mineralised matter being exposed to weathering conditions and undergo oxidation due to the presence of oxygen in air, sunlight, bacteria, formation of Fe(II)/Fe(III) couples leading to the eventual formation of sulphuric acid together with other acid-soluble constituents which are dissolved from the solid matter. These acidic, metal-contaminated solutions are referred to as Acid Drainage (AD) or Acid Mine Drainage (AMD). Depending upon the sulphide minerals present, the acid soluble minerals present and the volume of water passing through the mineralised system at any time, the solution pH and the metal ion concentrations can vary. Thus, recovery of the valuable metal ions, particularly copper and cobalt and especially when both are present, by application of ion exchange resins or solvent extraction processes is difficult, if not impossible. Furthermore, it is difficult to prevent traces of the kerosene used as a diluent in the solvent extraction process from entering the environment. Commercially available ion exchange resins and solvent extractants will favour the loading of iron, reducing the ability to load copper or cobalt. Furthermore, these commercially available extractants will not recover both cobalt and copper in a single step.

The application of PAI-based polymers may be used to capture copper and cobalt. They have the advantage over polyethyleneimine-based polymers as described in WO01/34856 insofar as formulated polymers, as described in the examples, can extract copper and allow iron and aluminium to remain in solution. After membrane concentration, the valuable metals may be recovered by direct electrolysis in a membrane electrowinning cell, or by acidification and electrolysis.

(c) Membrane Counter Current Processes.

In a further embodiment, it has been shown that an acid drainage solution can be pumped in the shell side of a hollow fibre membrane cell at a pressure slightly more positive than the pressure within the lumens. A solution of the water soluble PAI-based polymer is pumped through the lumens. The metal ions will then pass through the pores of the membrane and co-ordinate or complex with the PAI-based polymer. In this way, the metal ions are removed from the waste solution and concentrated by the PAI-based polymer.

Embodiments of the invention will now be described in more detail with reference to the following examples which exemplify the invention only and should not be taken as limiting on the invention in any way.

### EXAMPLE 1

A 200% stoichiometric solution of Lupsol SK, (a modified PAI, manufactured by BASF AG, Germany, of the type contemplated by this application) was added to an acid mine drainage solution containing 94 ppm of copper and 312 ppm of iron and at a pH of 2.57. No precipitation of iron or copper occurred. The copper complexed with the PAI and was membrane separated into the retentate. Comparatively, Lupasol P, (a polyethyleneinmine manufactured by BASF AG., Germany and contemplated by WO01/34856) when added to the same acid mine drainage solution at the same pH resulted in portion of the polymer and the iron forming a precipitate.

### EXAMPLE 2

Lupasol SK was hydroxamated and then added to the acid mine drainage solution given in Example 1. Again, the iron was not complexed by the polymer. The concentration of the copper in solution was reduced to 31 ppm.

### EXAMPLE 3

Lupasol SK and Lupasol P were both chemically modified at their nitrogen sites to form dithiocarbamate groups. When these polymers were added to the acid mine drainage solution described in Example 1, both copper and cobalt formed a precipitate with the dithiocarbamate-modified polymers. The precipitates, when subjected to the standard TCLP (Toxic Characterisation Leaching Procedure—USEPA Method) resulted in <0.01 g/t copper or cobalt being dissolved.

### EXAMPLE 4

A copper-gold ore was leached with sodium cyanide under alkaline conditions to produce a solution containing 2640 ppm copper cyanide and 1.22 g/t gold cyanide. The copper-bound cyanide accounted for about 84% of total cyanide, with about 76% of copper-bound cyanide being present as Cu(CN)₃²⁻, and about 24% as Cu(CN)₄³⁻. Some 2% of the cyanide in solution had been oxidised to cyanate, CNO⁻, and about 6% had reacted with sulphides to form thiocyanate, SCN⁻. A 50% aqueous solution of Lupasol LU243 (a mixed amine soluble polymer contemplated by this application and which is manufactured by BASF AG., Germany), was added to achieve a 110% stoichiometric addition based on the copper in solution. Duration of the complexation was 60 minutes and no oxygen sparging was employed. The titratable cyanide as a percentage of total cyanide before complexation was approximately 22% and after complexation was approximately 95%.

The reference to any prior art in this specification is not, and should not be taken as, an acknowledgment or any form of suggestion that that prior art forms part of the common general knowledge in Australia.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Those skilled in the art will appreciate that the invention described herein is susceptible to variations and modifications other than those specifically described. It is to be understood that the invention includes all such variations and modifications which fall within its spirit and scope. The invention also includes all the steps, features, compositions and compounds referred to or indicated in this specification, individually or collectively, and any and all combinations of any two or more of said steps or features.

1. A process for the recovery or removal of metal species from a solution or slurry comprising the steps of:
(a) contacting the solution or slurry with a poly(alkyleneimine) polymeric material to load the poly(alkyleneimine) polymeric material with metal species;
(b) separating the loaded poly(alkyleneimine) polymeric material from the solution or slurry; and
(c) recovering or removing the metal from the poly(alkyleneimine) polymeric material.

2. A process according to claim 1, wherein said solution or slurry is a leach solution or slurry which contains metal ions or metal complexes and wherein the leach solution or slurry is contacted with the poly(alkyleneimine) polymeric material for a period sufficient for the metal species to be bound to the poly(alkyleneimine) polymeric material, and with anionic species such that at least a portion of ligands of the metal complexes are displaced therefrom and returned to the leach solution or slurry whereby, if the displaced ligands act as a lixiviant, they are then available to react with further metal values.

3. A process according to claim 1, wherein the poly(alkyleneimine) polymeric material includes a poly(alkyleneimine) polymer incorporated into a superhydrophilic urethane-urea or a polystyrene divinyl benzene or acrylic resin.

4. A process according to claim 1 wherein the poly(alkyleneimine) polymeric material includes a poly(alkyleneimine) polymer containing primary, secondary and tertiary amine functionality.

5. A process according to claim 1, wherein the poly(alkyleneimine) polymeric material maintains its water solubility over the pH range of 1-14.

6. A process according to claim 1, wherein the poly(alkyleneimine) polymeric material includes a poly(alkyleneimine), grafted onto a nitrogen-containing polymer backbone selected from polyethyleneimine, poly(allylamine), poly(vinylamine) and polyacrylamides, or a polymer backbone such as poly(acrylonitrile), poly(vinyl alcohol).

7. A process according to claim 6, wherein the poly(alkyleneimine) polymeric material includes polyethyleneimine chains grafted onto a nitrogen-containing polymer selected from linear polyethyleneimine, branched polyethyleneimine, poly(vinylamine), poly(allylamine) and polyacrylamide by causing ethyleneimine monomer to react onto a percentage of the primary amine groups present in the base polymer structure, to form pendant polyethyleneimine chains.

8. A process according to claim 7, wherein the molecular weight of the polymer used as the polymer backbone for the grafting step is from about 100 to 1,000,000.

9. A process according to claim 7, wherein the molecular weight of the pendant polyethyleneimine portions is from about 500 to 50,000.

10. A process according to claim 1, wherein the poly(alkyleneimine) polymeric material includes a poly(alkyleneimine) based polymer obtained by reacting primary amines present on two branched polyethyleneimine chains with alkoxy or alkyl functional molecules of variable chain length.

11. A process according to claim 10, wherein the poly(alkyleneimine) based polymer is crosslinked by a base-catalysed condensation reactions using dicarboxylic acids, diesters, acid chloride derivatives of dicarboxylic acids, diacyl chlorides, dialkyl chlorides, poly(ethylene oxide), poly(propylene oxide), poly(butylene oxide) or diisocyanates or other reactant to significantly increase the molecular weight of the poly(alkyleneimine) based polymer and significantly reduce the charge density of the final polymer.

12. A process for the recovery of metal species from a solution or slurry containing metal cyanide species, comprising the steps of:
(a) contacting the solution or slurry with a water soluble poly(alkyleneimine) polymeric chelating or co-ordinating agent, preferably containing sodium benzoate, to load the water soluble polymeric agent with the metal species;
(b) separating the loaded water soluble polymeric agent by membrane separation such that cyanide is displaced and reports in the permeate and complexed metal species reports in the retentate;
(c) recovering the metal species from the retentate.

13. A process according to claim 12, wherein, if any free cyanide exists in the cyanide-containing aqueous stream, it is removed by membrane separation prior to the introduction of the water soluble polymeric agent.

14. A process according to claim 13, wherein membrane separation is conducted using a polysulphone-based membrane.

15. A process according to claim 12, wherein the water soluble poly(alkyleneimine) polymeric chelating or co-ordinating agent is a chemically modified water soluble chelating or co-ordinating agent which includes polyethyleneimine or poly(alkyleneimine) based polymers onto which ditihiocarbamate groups have been formed.

16. A process according to claim 12, wherein the process is conducted under alkaline conditions thereby effectively eliminating the formation or evolution of HCN.

17. A process for the recovery of metal species from a solution or slurry containing metal cyanide species, comprising steps of:
(a) contacting the solution or slurry with a poly(alkyleneimine) water insoluble polymeric chelating or co-ordinating agent to load the water insoluble polymeric agent with the metal species;
(b) separating the loaded water insoluble polymeric agent by either solid/liquid separation such that cyanide which is displaced reports in the aqueous phase and complexed metal species reports in the solid phase or the organic phase;
(c) recovering the metal species from the solid or from the organic phase.

18. The process of claim 4, wherein said poly(alkyleneimine) polymer contains quaternary amine functionality.

19. The process of claim 6, wherein said poly(alkyleneimine) polymeric material includes polyethyleneimine.

20. The process of claim 7, wherein the poly(alkyleneimine) polymeric material includes polyethyleneimine chains grafted onto a nitrogen-containing polymer selected from linear polyethyleneimine, branched polyethyleneimine, poly(vinylamine), poly(allylamine) and polyacrylamide by causing ethyleneimine monomer to react onto a percentage of the primary amine groups present in the base polymer structure by an acid catalysed reaction to form pendant polyethyleneimine chains.

21. The process of claim 8, wherein the molecular weight of the polymer used as the polymer backbone for the grafting step is from about 50,000 to 500,000.

22. The process of claim 12, further comprising the step (d) of recirculating the cyanide-rich permeate from step (b) and/or water soluble polymeric agent-rich solution following step (c).

23. The process of claim 17, further comprising the step of (d) recirculating the cyanide-rich solution from step (b) and/or the solid or the water-insoluble polymeric agent-rich solution following step (c).
